(19) United States
(12) Patent Application Publication
(10) Pub. No.: US 2017/0015324 A1
(43) Pub. Date: Jan. 19, 2017

(54) METHOD FOR CONTROLLING START OF ISG VEHICLE

(71) Applicants: Hyundai Motor Company, Seoul (KR); Kia Motors Corp., Seoul (KR)

(72) Inventor: Joung Chul KIM, Suwon-si (KR)

(73) Assignees: Hyundai Motor Company, Seoul (KR); Kia Motors Corp., Seoul (KR)

(21) Appl. No.: 14/942,542

(22) Filed: Nov. 16, 2015

(30) Foreign Application Priority Data
Jul. 14, 2015 (KR) 10-2015-0099719

(51) Int. Cl. B60W 30/18; B60W 50/00; B60W 30/188; B60W 30/186; B60W 10/06; B60W 10/02

(52) U.S. Cl. CPC B60W 30/18018; B60W 10/06; B60W 10/02; B60W 30/1884; B60W 30/186; B60W 50/0098; B60W 2540/10; B60W 2540/12; B60W 2710/027; B60W 2710/0666; B60W 2710/025

(57) ABSTRACT

A method for controlling start of an ISG (idle stop and go) vehicle may include an operation of limiting, when an ISG mode of the vehicle is turned off, an engine torque to less than a preset value for a predetermined time from a point of time at which the IGS mode is turned off.

### CROSS REFERENCE TO RELATED APPLICATION

The present application claims priority to Korean Patent Application No. 10-2015-0099719, filed Jul. 14, 2015, the entire contents of which is incorporated herein for all purposes by this reference.

### BACKGROUND OF THE INVENTION

Field of the Invention

The present invention relates to a method for controlling start of an Idle Stop and Go (ISG) vehicle, and more particularly to a method for controlling start of an ISG vehicle in such a way that the torque of an engine is adjusted after an ISG function is turned off, thus mitigating shock generated when a clutch is engaged.

Description of Related Art

Recently, for transmissions installed in environmentally-friendly vehicles, automated manual transmissions (AMTs) including dual clutch transmissions (DCTs) which have comparatively high fuel efficiency are in the spotlight.

AMTs refer to a transmission which has mechanism for automating manual transmissions. Such an AMT automatically conducts a clutching operation for controlling power input from an engine to the transmission, and a selecting and shifting operation for substantially changing gears in the transmission

DCTs include two gear shafts for odd and even gear sets in a single transmission housing so as to reduce shifting shock in such a way that while engine torque is applied to one gear shaft, one of the gears of the other gear shaft can be pre-selected, thus reducing the time it takes to shift gears, providing performance with enhanced direct feeling, and enhancing fuel efficiency of the transmission.

Meanwhile, Idle Stop and Go (ISG) function, which can enhance fuel efficiency of vehicles, is recently applied to various kinds of vehicles. The ISG function is a technology designed to turn off the ignition of a vehicle automatically when the vehicle stops, thus preventing unnecessary fuel consumption resulting from idling of the engine.

Recently, research on the technology of applying the ISG function to a vehicle provided with a DCT and thus maximizing the fuel efficiency has become appreciably more active.

In the case of a vehicle provided with a DCT having no ISG function, the engine is maintained in an ignition on state even when the vehicle stops. Thus, when the vehicle starts to move, smooth and rapid start of the engine can be realized because balance control of engine torque and clutch torque can be appropriately embodied. However, in the case of a vehicle having the ISG function, when the vehicle starts to move, it is difficult to provide smooth start acceleration effect because operation of turning on the ignition of the engine is required.

That is, when the vehicle, which has stopped while the ISG function is turned on, quickly starts and accelerates, the ISG function is turned off. Then, the engine torque is rapidly increased, and the RPM of the engine is excessively increased. As a result, excessive slip occurs in the clutch. Here, when a start clutch is engaged, an overshoot phenomenon of the engine and shock and jerk phenomenon are caused, thus making the driver or a passenger feel discomfort, and increasing the possibility of the clutch burning.

For example, FIG. 1 is a graph showing variation in characteristic values as a function of vehicle start control according to a conventional technique. Referring to FIG. 1, while the IGS function is turned on, when the accelerator opening degree is increased by quick start of the vehicle, the engine torque is rapidly increased. Thereby, the RPM of the engine is rapidly increased. Here, an input shaft of the clutch is coupled to the engine while the clutch torque is also increased. However, since there is a large difference between the RPM of the engine and the RPM of the input shaft, a load of the input shaft is excessively applied to the engine. As a result, the RPM of the engine excessively varies. As shown in the drawing, it can be understood that the acceleration of the vehicle is excessively varied by such variation in RPM of the engine, thus causing a jerk phenomenon, thereby making the driver feel discomfort and unfamiliarity.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a method for controlling start of an ISG vehicle which can prevent the torque of an engine from being excessively rapidly increasing when the vehicle starts after an ISG function is turned off, thus preventing shock or clutch burning from being caused when the clutch is engaged.

According to one aspect, there is provided a method for controlling start of an ISG (idle stop and go) vehicle, including: limiting, when an ISG mode of the vehicle is turned off, an engine torque to less than a preset value for a predetermined time from a point of time at which the IGS mode is turned off.

The method may further include, after limiting the engine torque, increasing the engine torque at a pre-mapped gradient in response to an accelerator opening degree.

Furthermore, increasing the engine torque may further include controlling a clutch torque to be variable based on at least one of the engine torque and the accelerator opening degree.

After an ignition is turned on by releasing a brake pedal or pressing an accelerator pedal while the ISG mode is turned on, the ISG mode of the vehicle may be turned off when an RPM of the engine is increased to a reference value or more.

The vehicle may comprise a vehicle provided with an automated manual transmission.

In a method for controlling start of an ISG vehicle according to the present invention, after an ISG function is turned off, the engine torque is controlled. Therefore, when the vehicle starts, a jerk phenomenon, which results from engagement of the clutch when the vehicle starts quickly in the ISG on state, or a clutch burning phenomenon, which is caused by excessive slip of the clutch, can be prevented.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a graph showing variation in characteristic values as a function of vehicle start control according to a conventional technique.

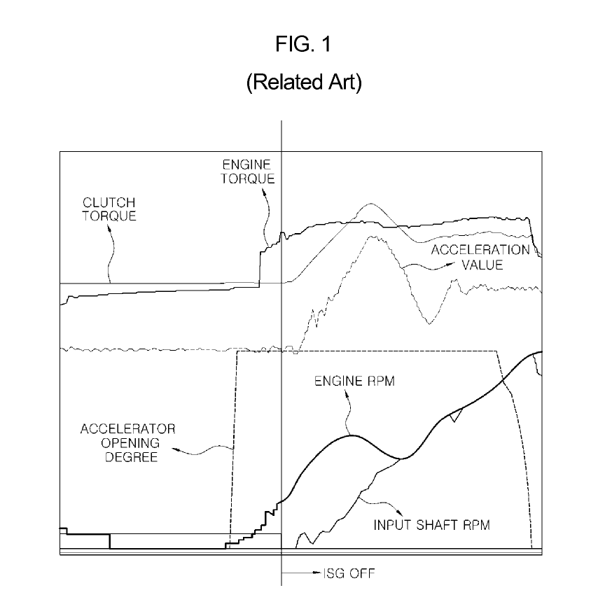

FIG. 2 is a flowchart showing a method for controlling start of an ISG vehicle according to an embodiment of the present invention.

FIG. 3 is a graph showing variation in characteristic values according to an embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinbelow, a method for controlling start of an ISG vehicle according to an exemplary embodiment of the present invention will be described in detail with reference to the accompanying drawings.

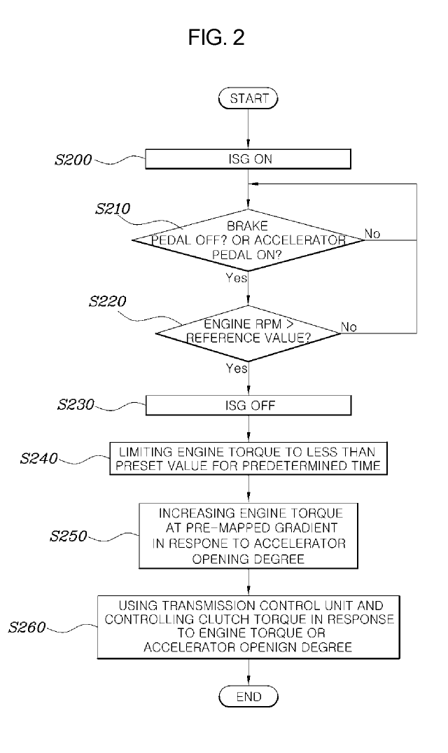

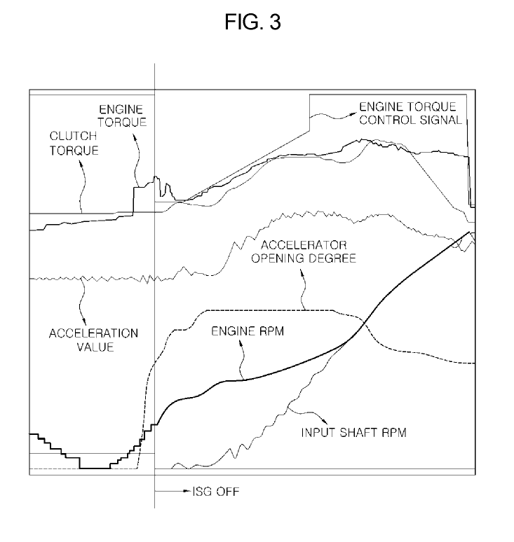

FIG. 2 is a flowchart showing the method for controlling start of the ISG vehicle according to the exemplary embodiment of the present invention. FIG. 3 is a graph showing variation in characteristic values according to the exemplary embodiment of the present invention. Referring to FIGS. 2 and 3, the start control method of the vehicle includes operation S240 of, when an ISG function of a vehicle is turned off, limiting an engine torque to less than a preset value for a predetermined time from a point of time at which the ISG function is turned off.

When the ISG function of the vehicle is turned on, the engine is stopped to reduce fuel consumption resulting from unnecessary idling. In operation S240, when a driver presses an acceleration pedal to accelerate the vehicle, the IGS function is turned off and the ignition of the vehicle is turned on to operate the engine, whereby the vehicle begins to move.

However, depending on characteristics of the driver or driving conditions, the vehicle may be excessively quickly started and rapidly accelerated. In this case, because the engine torque is rapidly increased, the RPM of the engine is excessively increased, and excessive slip occurs in a clutch. Here, when the clutch is engaged to move the vehicle, an excessive load may be applied to the engine because the engine is connected to an input shaft of a transmission while the engine rotates at high speed. Thereby, an engine overshooting or clutch burning phenomenon may be caused.

To avoid the above problems, the present invention is configured such that, when the IGS function is turned off before the clutch is engaged to move the vehicle, the engine torque is limited to less than a preset value for a predetermined time. That is, in the conventional technique, when the driver quickly starts the vehicle while the ISG function of the vehicle is in the turn-on state, the engine torque is rapidly increased after the ISG function is turned off. However, the present invention restricts a rapid increase of the engine torque just after the ISG function is turned off and thus enables the clutch to be engaged while the engine rotates comparatively slowly. Thereby, even when an excessive load is input, a jerk phenomenon is not caused, and the clutch can be prevented from burning.

The preset value is a value that is set by a designer to prevent the engine torque from rapidly increasing and may be changed depending on the kind of vehicle.

The start control method according to the present embodiment further includes operation S250 of increasing the engine torque at a pre-mapped gradient in response to an accelerator opening degree after the torque limit operation S240 has been conducted.

In the case where the engine torque is limited to less than the preset value after the ISG function is turned off, even if the driver variably manipulates the accelerator pedal, there is no unfamiliarity in driving. For this, in an exemplary embodiment of the present invention, after the torque limit operation S240 is conducted, the engine torque is controlled to be increased in proportion to the degree of opening of the accelerator pedal, thus providing linear start acceleration in response to the accelerator opening degree.

Here, the engine torque is increased at a pre-mapped gradient in response to the accelerator opening degree. This differs from the conventional configuration in which the engine torque is increased only in response to the accelerator opening degree. In detail, in the conventional technique, the engine torque may be rapidly increased in response to the accelerator opening degree without limit. However, in the present embodiment, the engine torque is increased in proportion to the accelerator opening degree, wherein the engine torque is controlled to be increased at a gradient limited as a function of the accelerator opening degree. Therefore, the engine torque can be prevented from being excessively rapidly increased. Moreover, because the present embodiment is also configured such that the engine torque is increased in response to the accelerator opening degree, satisfactory acceleration effect can be provided.

The pre-mapped gradient is a gradient that is set by a designer to a predetermined value depending on the kind of vehicle such that the engine torque is appropriately increased. Although the gradient is mapped such that it is increased in proportion to the accelerator opening degree, it is preferable that the gradient of the present embodiment be less than an actual gradient at which the engine torque is increased in response to the accelerator opening degree in the conventional technique.

The torque increase operation S250 further includes operation S260 of controlling a clutch torque to be variable based on at least one of the engine torque and the accelerator opening degree.

In other words, when the torque increase operation S250 is conducted, the clutch torque is increased in proportion to at least one of the accelerator opening degree and the engine torque that increases in response to the accelerator opening degree. Thereby, the engagement operation of the clutch can be smoothly conducted. For instance, the clutch torque may also be controlled to be increased at a pre-mapped gradient in response to the accelerator opening degree in the same manner as that of controlling the engine torque. Alternatively, the clutch torque may be controlled in such a way that it is applied in proportion to the engine torque.

In brief, in the present embodiment, after the ISG function of the vehicle is turned off, the engine torque is controlled to be less than a preset value for a predetermined time. Subsequently, the engine torque and the clutch torque are controlled to be linearly increased in response to the accelerator opening degree. Thereby, when the vehicle moves after the ISG function is turned off, a jerk phenomenon can be prevented from occurring due to a rapid increase in RPM of the engine, and the clutch can be prevented from burning because of excessive slip. Moreover, linear start-acceleration effect can be provided.

The engine torque is controlled by an engine management system (EMS) or engine control unit (ECU). The clutch torque is controlled by a transmission control unit (TCU).

That is, the EMS, which is used for electronic control of every engine, may autonomously control the engine torque. Alternatively, the ECU provided in the EMS may conduct the start control method according to the present embodiment.

The TCU is a control unit which controls the clutch torque to be variable depending on driving conditions of the vehicle. As stated above, the TCU provides clutch torque which varies depending on at least one of the accelerator opening degree and the engine torque.

Here, the ISG function of the vehicle is characterized in that after the ignition is turned on (S210) by releasing the brake pedal or pressing the accelerator pedal while the ISG function is turned on (S200), the ISG function is turned off when the RPM of the engine is increased to a reference value or more (S220).

In detail, when the driver releases the brake pedal or presses the accelerator pedal to accelerator the vehicle, the RPM of the engine is increased to restart the engine of the vehicle that has been stopped. When the RPM of the engine becomes a reference value or more, it begins to control the engine torque depending on the accelerator opening degree. For this, the ISG function is turned off (S230), and the torque limit operation S240 is conducted. Here, the reference value refers to the minimum value of the RPM of the engine that is required to start the vehicle.

Furthermore, the vehicle according to the present embodiment is a vehicle provided with a dual clutch transmission (DCT) or an automated manual transmission (AMT).

Referring to FIG. 3, when the driver presses the accelerator pedal while the ISG function is turned on, the accelerator opening degree is greatly increased, whereby the engine torque is increased to restart the engine. When the ignition of the engine is turned on and the engine torque becomes a predetermined value or more, the ISG function is turned off because it is determined that the ignition of the engine has been completed. Here, the EMS or ECU outputs an engine torque control signal so that the engine torque is maintained less than the preset value for a predetermined time. After the predetermined time has passed, the engine torque is increased at a pre-mapped gradient in response to the accelerator opening degree. Thereafter, after the predetermined time has passed or the clutch has been engaged, the EMS or ECU stops outputting the engine torque control signal. It can be appreciated that, in the same manner as the engine torque, the clutch torque is controlled to be increased in response to the accelerator opening degree or the engine torque

In accordance with the present embodiment, as shown in the lower portion of FIG. 3, the RPM of the engine is gently increased. Therefore, a difference between the RPM of the engine and the RPM of the input shaft is reduced, whereby when the clutch is engaged, the vehicle can smoothly and rapidly start to move. This can be understood by the fact that the acceleration is gently increased without changing greatly.

As described above, in accordance with a method for controlling start of an ISG vehicle according to an exemplary embodiment of the present invention, after an ISG function is turned off, the engine torque is controlled. Therefore, when the vehicle starts, a jerk phenomenon, which results from engagement of the clutch when the vehicle starts quickly in the ISG on state, or a clutch burning phenomenon, which is caused by excessive slip of the clutch, can be prevented.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method for controlling start of an idle stop and go (ISG) vehicle, comprising:
limiting, when an ISG mode of the vehicle is turned off, an engine torque to less than a preset value for a predetermined time from a point of time at which the IGS mode is turned off.

2. The method according to claim 1, further comprising, after limiting the engine torque,
increasing the engine torque at a pre-mapped gradient in response to an accelerator opening degree.

3. The method according to claim 2, wherein increasing the engine torque further comprises
controlling a clutch torque to be variable based on at least one of the engine torque and the accelerator opening degree.

4. The method according to claim 1, wherein after an ignition is turned on by releasing a brake pedal or pressing an accelerator pedal while the ISG mode is turned on, the ISG mode of the vehicle is turned off when an RPM of the engine is increased to a reference value or more.

5. The method according to claim 1, wherein the vehicle is provided with an automated manual transmission.
